(19) United States
(12) Patent Application Publication
(10) Pub. No.: US 2006/0075428 A1
(43) Pub. Date: Apr. 6, 2006

(54) Minimizing channel change time for IP video

(75) Inventors: James O. Farmer, Cumming, GA (US); Stephen A. Thomas, Marietta, GA (US)

Correspondence Address: KING & SPALDING LLP, 191 PEACHTREE STREET, N.E., 45TH FLOOR, ATLANTA, GA, 30303-1763, US

(73) Assignee: Wave7 Optics, Inc., Alpharetta, GA (US)

(21) Appl. No.: 11/243,463

(22) Filed: Oct. 4, 2005

Related U.S. Application Data
(60) Provisional application No. 60/615,856, filed on Oct. 4, 2004.

(51) Int. Cl. H04N 5/445; H04N 5/50

(52) U.S. Cl. 725/38; 348/732

(57) ABSTRACT

Subscribers to Internet Protocol TV services usually complain about one key characteristic—the additional delay digital video introduces when subscribers change channels, especially when subscribers “channel surf.” The problem is traced to at least three sources of delay in a convention Internet Protocol video deployment system. The channel changing delay can be minimized by caching video packets for the most likely next channel in a buffer in anticipation of a television subscriber changing channels and/or by having an adaptable buffer length in the set top box.

### RELATED APPLICATIONS

The present application claims priority under 35 U.S.C. § 119(e) to provisional patent application entitled, “MINIMIZING CHANNEL CHANGE TIME FOR IP VIDEO,” filed on Oct. 4, 2004, and assigned U.S. Application Ser. No. 60/615,856; the entire contents of which are hereby incorporated by reference.

### FIELD OF THE INVENTION

The invention relates to techniques than can be used to minimize the channel change time for Internet Protocol (IP) Video. More particularly described, the invention can reduce the channel changing delay by caching video packets for the most likely next channel in a buffer in anticipation of a television subscriber changing channels and by having an adaptable buffer length in the set top box.

### BACKGROUND OF THE INVENTION

In the conventional art, video is typically sent via radio-frequency (RF) broadcast. The broadcast method has been used by off-air television stations, cable television systems, and satellite broadcasters, since the beginning of television. Within the category of broadcast television, there are two types of signals, analog and digital. FIG. 1 is a block diagram illustrating the operating environment of a conventional TV video deployment 100. The TV signals 110, whether analog or digital, are passed through a RF modulator 120 which puts the TV signal 110 onto a modulated RF carrier 125 at a particular frequency and then sent to many subscribers simultaneously. The multiple TV signals 110 are then combined in a combiner 130 and transmitted into the home. At the home, subscribers typically tune a channel with a television 180 for analog signals and with a set top box 180 for digital signals; however, a subscriber might tune analog signals through the set top box 180 for convenience. The television or set top box 180 can contain a mixer 140 and local oscillator 150 that can function to convert the selected signal to an intermediate frequency (IF) that is then amplified, filtered, and demodulated to produce the original TV Signal 110. In the case of digital signals, an additional decoding step 160 is performed to decompress the signal, preparing it for display on the TV screen 170. When the subscriber tunes the signal, he or she is adjusting the frequency of the local oscillator 150 such that it is higher than the frequency of the desired modulated TV signal by an amount equal to the IF frequency. The mixer 140 then combines the received signal and the local oscillator 150 signals in such a way that the difference signal is produced. The set top box or television can decode the incoming signal with a decoder 160 in order to allow the TV screen 170 to display the signal.

Besides broadcasting, there are other video delivery systems, including cable, satellite, DSL, and broadcast transmissions through Fiber-to-the-Home (FTTH) systems. An increasingly popular method of transmitting digital video is IP Television (TV) because of the numerous advantages it provides for network providers to offer video services more efficiently in certain cases. For example, IPTV is ideal for programs intended for use by only one subscriber, because a minimum amount of the network is tied up to serve that need. Furthermore, in contrast to broadcast video, IPTV has no inherent limitation in the number of channels that can be offered for transmission. Therefore, the number of channels that can be carried to subscribers can be significantly higher when compared to traditional video delivery systems and depending on the transmission capacity of the network and how much of that capacity is devoted to IPTV. Finally, the same data transmission capacity of a network can be used for all other data traffic. A conventional IP video deployment that uses IPTV will be discussed below.

FIG. 2 is a block diagram illustrating the operating environment of a IPTV video network 200. A TV signal 210 passes through an IPTV encoder 220 where the signal is digitized and processing is used to compress, or eliminate unnecessary (“redundant”) information in order to minimize the bandwidth. Digital video relies on standards developed by the Motion Pictures Expert Group (MPEG) for its formatting and transport. These standards, known collectively as MPEG, define an approach for compressing the video content and significantly reducing the bandwidth required to transfer it. The MPEG compression creates a stream of individual packets or frames, each carrying some video content. The MPEG compression will be discussed in more detail in relation to FIG. 3 below.

From the IPTV encoder 220, the stream of individual IPTV packets passes through a series of routers and switches 230A, 230B, 230C until they reach the subscriber's location. At the subscriber's location, typical deployments of IP video services rely on three main systems: customer premise equipment (CPE) 260, a set top converter or set top box (STB) 270, and the subscriber's television 280 or video receiver. The CPE 260 provides a connection to the network 200 and is coupled to a router or switch 230C. In turn, the CPE 260 is coupled to a STB 270 typically using an Ethernet type of link. Finally, the STB 270 is coupled and passes the video signals to the subscriber's television or video receiver 280. The connection from the STB 270 to the television 280 may be standard coaxial cable carrying an RF modulated signal, or it may be an alternative video connection such as S-Video or FireWire.

In the IPTV video deployment system 200, the IP video signals are received by the CPE 260 as IP multicast (or unicast, as is understood by one of ordinary skill in the art) streams delivered from the network 200. To avoid sending all channel signals simultaneously, each multicast video channel uses a specific IP multicast identification. The CPE 260 communicates with the network 200 to identify which channel the user desires to view or is currently viewing. The signaling information is carried using the Internet Group Management Protocol (IGMP).

Therefore, when a user changes the channel on the STB 270, the STB 270 transmits an IGMP “join” message 285 to the network 200 for the new channel. The IGMP “join” message 285 is sent upstream back through the routers and switches 230A, 230B, 230C to look for the appropriate channel signal. When the appropriate signal is located, the packets bearing the multicast identification 290 for the new channel can be transmitted downstream to the CPE 260 and STB 270 which relays the signal to the subscriber's TV 280. Furthermore, when STB 270 tunes to the new channel, the STB 270 or CPE 260 sends an IGMP “leave” message 295 for the previous channel.

As understood by one or ordinary skill in the art, if a program is intended for one and only one subscriber, multicasting is replaced by unicasting. Both multicasting and unicasting fall within the scope of the instant teaching. An example of a unicast program would be a video-on-demand (VOD) program, which by definition is intended for one and only one subscriber.

FIG. 3 is a graph illustrating the transmission of IP video packets 300 over a network 200. As previously discussed, digital video relies on MPEG standards for its formatting and transport. These standards define an approach for compressing the video content and significantly reducing the bandwidth required to transfer it. MPEG compression creates a stream of individual packets or frames, each carrying some video content. As FIG. 3 illustrates, the stream contains packets of three different types of frames: I-frames 310, 360; B-frames 320, 340, 370; and P-frames 330, 350, 380.

The Intra-frame, or I-frame, is typically considered to be the fundamental frame of a digital video signal. A STB 270 can completely reconstruct a video picture by decoding the contents of an I-frame. Therefore, because one frame of a picture is fairly similar to the next, less I-frames must be transmitted, as the STB 270 can use the one I-frame for constructing subsequent frames. This is advantageous because I-frames require a large amount of data; therefore, transmitting a large number of them could reduce network bandwidth.

To assist in constructing the picture frames, two other types of frames are transmitted: P-frames, or predictive frames, and B-frames, or bi-directional frames. P-frames and B-frames use both spatial and temporal compression. Spatial compression eliminates redundant data in an individual frame. For temporal compression, the frames reference the previous I-frame in the stream. In simplified terms, P-frames and B-frames usually only contain the differences in the picture that have appeared since the last I-frame. As a consequence, a decoder in a STB 270 typically cannot reconstruct a complete picture from a P-frame or B-frame because it must also have access to the preceding I-frame.

In FIG. 3, an I-frame 310 is transmitted followed by a plurality of B-frames 320, 340 and P-frames 330, 350. The B-frames and P-frames will continue to be transmitted until it is time for another I-frame to be transmitted. The common practice in the industry is for the IPTV encoder 220 to transmit two I-frames every one second. The amount of time to allow between transmissions of I-frames 390 depends on many factors. First, the I-frame usually must be transmitted every so often because if it was not, the prediction from one frame to the next would get progressively worse until the IPTV encoder 220 was transmitting so much predictive error information the picture would not be adequate. In the alternative, because I-frames require so much data, transmitting too many of them could put a strain on the network bandwidth.

The last factor in determining how often to transmit I-frames relates to when a subscriber is changing channels. For example, suppose a subscriber turns to the channel with the channel stream represented in FIG. 3. If the subscriber, turns to the channel immediately before the I-frame 310 is transmitted, very little delay will be experienced because as soon as I-frame 310 is transmitted to the STB 270, the STB 270 will reconstruct a picture on the television 280. However, suppose the subscriber turns to the channel and only receives a portion of I-frame 310 or begins receiving the stream at B-frame 320. In those scenarios, the STB 270 does not receive a complete I-frame; therefore, it cannot reconstruct the video picture. Furthermore, the B-frames 320, 340 and P-frames 330, 350 that the STB 270 begins to produce are of no value because the STB 270 does not have a copy of the I-frame 310 to which they refer. Therefore, the STB 270 usually has little choice but to wait for the next I-frame 360 before it can begin reconstructing the picture.

The conventional IP video system described above provides many advantages to network service providers, including their ability to offer revolutionary video services. However, subscribers to IPTV services complain about one key characteristic—the additional time delay digital video introduces when subscribers change channels, especially when subscribers desire to “channel surf.” The architecture of the conventional IP video system introduces at least three sources of time delay. The aggregate of these three sources can create time delays of up to three seconds to change the channel.

One source of delay relates to the common practice of IPTV encoder manufacturers to transmit an I-frame about twice every second as discussed above. Therefore, when a STB 270 tunes to a new channel, it usually must wait on average of a quarter of a second before it can even begin displaying the new channel's picture. This delay can be one source of irritation to a subscriber, especially if the subscriber is attempting to rapidly scan through channels (“channel surfing”).

Another source of delay relates to the “jitter buffer” that occurs in a buffer found in the STB 270 decoder. The STB 270 decoder is responsible for receiving the incoming IP packet streams from the network 200 and decoding those packet streams in order for them to be displayed correctly on the subscriber's television 280. The buffer in the STB 270 decoder can be represented as a First-In-First-Out (FIFO) Shift Register. The buffer usually serves to delay all packets arriving at the STB 270 by some length of time chosen by the STB 270 manufacturer. This buffer is needed in order to prevent momentary picture “freezes,” which can occur if for some reason a packet is delayed in getting to the STB 270. To one of ordinary skill in the art, the buffer usually must be sized such that the longest packet delay time expected is less than the buffer length. Therefore, when a subscriber changes channels, the FIFO shift register begins filling up with frames that correspond to the channel currently requested by the subscriber. However, the FIFO shift register typically does not begin to transmitting the frames to the STB 270 decoder until the buffer is halfway full, causing a second time delay.

Finally, another source of delay that can occur in a conventional IPTV video system is illustrated in FIG. 2 above. Specifically, a delay can occur in the network 200 because it take time to propagate IGMP join messages 285 upstream to the head end of the network 200 through the routers and switches 230A, 230B, 230C in order to locate the multicast IPTV stream that applies to the requested channel.

In view of the foregoing, there is a need in the art to provide techniques than can be used to minimize the channel change time for IPTV. More particularly described, there is a need in the art to reduce the channel changing delay that can occur in networks using IPTV when a subscriber desires to “surf” through channels.

### SUMMARY OF THE INVENTION

The invention can reduce the delay that occurs when subscribers change channels while watching digital video delivered over broadband Internet Protocol (IP) networks. Specifically, the invention can reduce the channel changing delay when subscribers of the network “channel surf,” or activate a remote control to scroll through or quickly tune through channels in a serial manner to determine what they want to watch. The invention can reduce the channel changing delay by caching video packets for the most likely next channel in a buffer in anticipation of the subscriber changing channels and by having an adaptable buffer length in the set top box.

Digital video relies on standards developed by the Motion Pictures Expert Group for its formatting and transport. These standards, known collectively as MPEG, define an approach for compressing the video content and significantly reducing the bandwidth required to transfer it. In an IPTV encoder, MPEG compression creates a stream of three types of individual frames, each carrying some video content. One of the most important types of frames is known as an Intra-frame, or I-frame which uses various spatial compression techniques to minimize its size. Most importantly, though, a receiver can completely reconstruct a video picture using only the contents of the I-frame. The other two types of video frames, P-frames and B-frames, use both spatial and temporal compression which means they reference an I-frame in the stream. Therefore, P-frames and B-frames only contain the differences in the picture that have appeared since the last I-frame; and, as a consequence, a receiver cannot reconstruct a complete picture from a P-frame or B-frame only.

The IP video signals can be received by customer premise equipment as IP multicast streams delivered from the network. To avoid sending all channel signals simultaneously, each video channel can use a specific IP multicast identification and the customer premise equipment can signal to the network which channel the user is currently viewing or requesting. The signaling information can be carried using Internet Group Management Protocol (IGMP). Therefore, when a user changes the channel, the customer premise equipment can transmit an IGMP “join” message to the network for the new channel, and it can send an IGMP “leave” message for the original channel. The signaling information for the current channel can be transmitted to an IP set top box which relays the signal to the customer's TV.

According to one exemplary aspect of the invention, software located on either the customer premise equipment or set top box can monitor the current channel (multicast group) being transmitted to the customer's set top box and predict the next channel the customer may decide to tune. The potential future channels that the customer premise equipment may predict include: (1) the group corresponding to the television channel immediately following the tuned channel (in case the user is “surfing up”); (2). the group corresponding to the television channel immediately preceding the tuned channel (in case the user is “surfing down”); and/or (3). the group corresponding to the last television channel that the user was watching (in case the user is toggling between two channels). For these channels, instead of passing the streams from the network to the IP set top box, the customer premise equipment or set top box can cache the stream's content in local memory.

In order to reduce the channel change time, the customer premise equipment or set top box can manage the cache such that an MPEG I-frame, the most important type of frame, is always at the cache head. Therefore, when the user changes the channel to a cached stream, the customer premise equipment or set top box can immediately transmit the contents of its cache for that stream. During this time, additional content for the stream can continuously be added to the end of the cache as long as the subscriber is watching that channel.

For another exemplary aspect of the invention, the invention may be simplified by pre-caching only one I-frame in the customer premise equipment. When the user changes the channel, the single I-frame can then be supplied to the set top box. At that time, a normal IGMP join request can be transmitted upstream to locate the full program stream, while the single I-frame can be captured by the set top box. Each time an I-frame is received, it can be captured and replace the previous I-frame in the cache. Other data not related to the I-frame (such as B- and P-frames) can be discarded. In this alternative exemplary embodiment, the set top box decoder can capture and display that single I-frame as a still picture, until it begins receiving a full MPEG video stream for the selected channel. This can afford the subscriber a quick preview of the channel without requiring significant memory, and it can also simplify the transfer of picture content from the buffer in the customer premise equipment to going directly to the set top box.

For another exemplary aspect of the invention, the invention can reduce channel change time by using an adaptive buffer length in the set top box. The buffer in the set top box can comprise a first-in-first-out memory (FIFO), which serves to delay all packets arriving at the set top box by some length of time chosen by the set top box manufacturer. This buffer is usually needed in order to prevent momentary picture “freezes,” which can occur if for some reason a packet is delayed in getting to the set top box. However, different video delivery systems exhibit widely varied packet delay times; therefore, set top box manufacturers typically provide a buffer that is long enough to prevent picture freezes under the most severe conditions of packet delay variation.

In order to reduce the channel change time, data entering the FIFO buffer from the customer premise equipment can enter via a switch which is set to different positions by logic, depending on how long a buffer is needed. The switch can have a position where the buffer length is maximum, and the time required for a video signal to propagate through the buffer is maximum. Therefore, in this position, the channel change time will be maximum. Furthermore, at the opposite extreme, the switch can have a position where the buffer length is minimum, where the channel change time would be minimized because the new channel I-frame would propagate through the buffer in less time. Finally, the switch can have intermediate positions that allow the buffer size to be increased or decreased to certain lengths without reaching the maximum or minimum buffer length.

These and other aspects, objects, and features of the invention will become apparent from the following detailed description of the exemplary embodiments, read in conjunction with, and reference to, the accompanying drawings.

### BRIEF DESCRIPTION OF DRAWINGS

FIG. 1 is a block diagram illustrating the operating environment of a conventional TV video deployment.

FIG. 2 is a block diagram illustrating the operating environment of a conventional IPTV video deployment.

FIG. 3 is a block diagram illustrating the transmission of IP video packets over a network in a conventional IPTV video deployment.

FIG. 4 is a logic flow diagram illustrating an exemplary method for reducing channel change time in accordance with an exemplary embodiment of the invention.

FIG. 5 is a logic flow diagram illustrating an exemplary method for monitoring channel changing in accordance with an exemplary embodiment of the invention.

FIG. 6 is a block diagram illustrating basic elements of a customer premise equipment in accordance with an exemplary embodiment of the invention.

FIG. 7 is a block diagram illustrating basic elements of a customer premise equipment in accordance with an exemplary embodiment of the invention.

FIG. 8 is a block diagram illustrating further details of a customer premise equipment in accordance with an alternative exemplary embodiment of the invention.

FIG. 9A is a block diagram illustrating an adaptive variable length buffer in accordance with an exemplary embodiment of the invention.

FIG. 9B is a block diagram illustrating an adaptive variable length buffer in accordance with an alternative exemplary embodiment of the invention.

FIG. 10A is a graph illustrating the result of monitoring buffer fill over some length of time where the buffer length is sized correctly in accordance with an alternative exemplary embodiment of the invention.

FIG. 10B is a graph illustrating the result of monitoring buffer fill over some length of time where the buffer length is sized too small in accordance with an alternative exemplary embodiment of the invention.

FIG. 10C is a graph illustrating the result of monitoring buffer fill over some length of time where the buffer length is sized too large in accordance with an alternative exemplary embodiment of the invention.

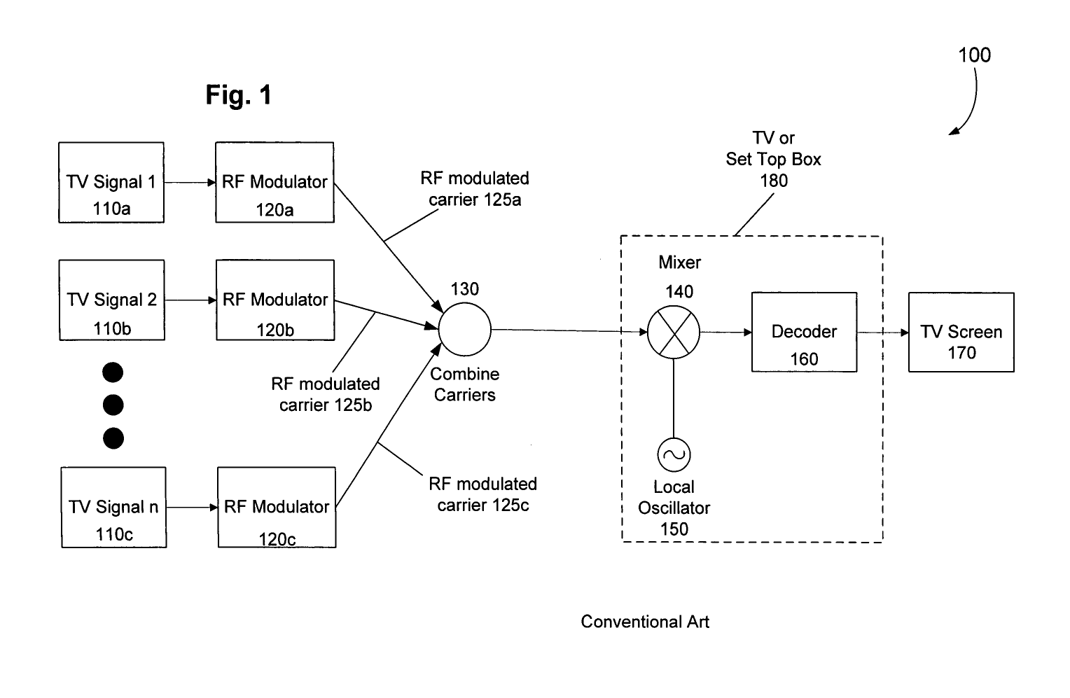

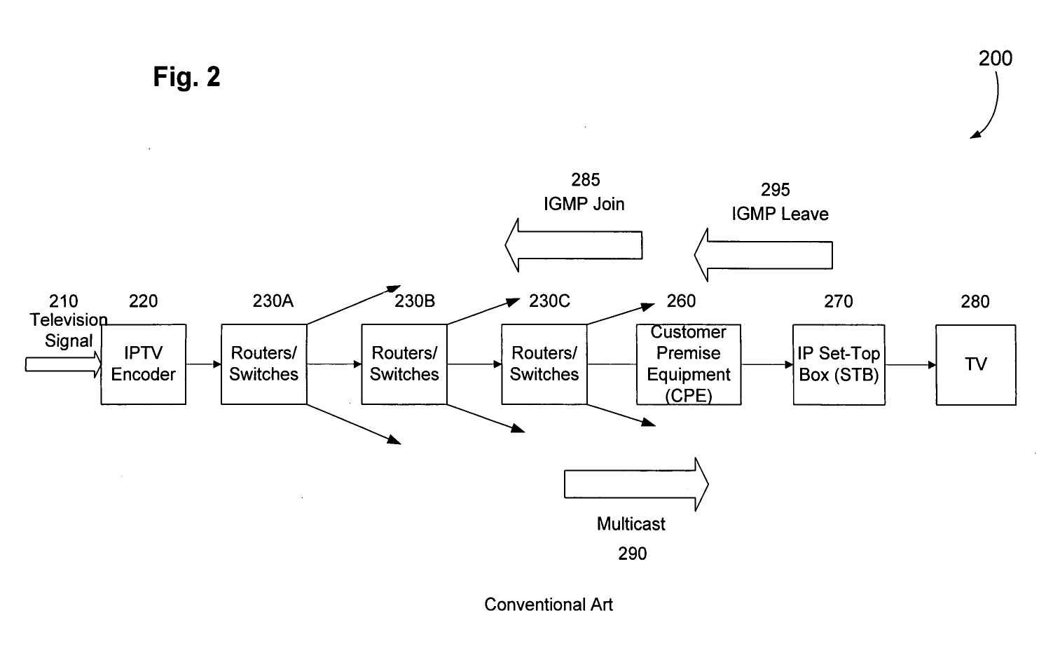

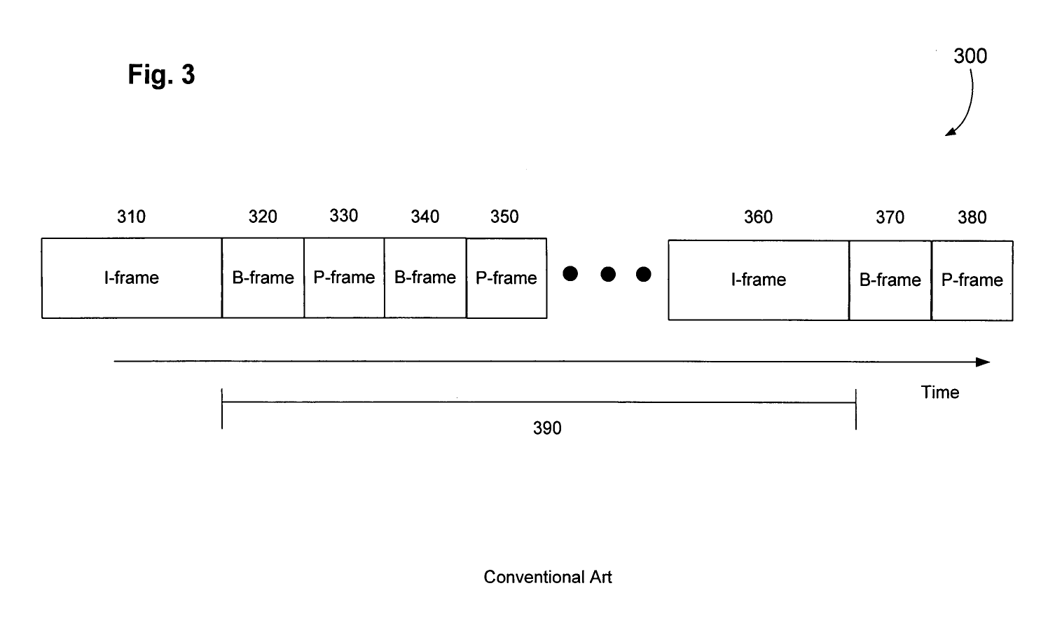

### DETAILED DESCRIPTION OF EXEMPLARY EMBODIMENTS

The invention relates to minimizing the delay that occurs when subscribers change channels while watching digital video delivered over broadband Internet Protocol (IP) networks. Specifically, the invention relates to reducing the channel changing delay when subscribers “channel surf.” The invention can reduce the channel changing delay by caching video packets for the most likely next channel in a buffer in anticipation of the subscriber changing channels and by having an adaptable buffer length in the set top box.

The description of the flow charts in this detailed description are represented largely in terms of processes and symbolic representations of operations by conventional computer components, including a processing unit (a processor), memory storage devices, connected display devices, and input devices. Furthermore, these processes and operations may utilize conventional discrete hardware components or other computer components in a heterogeneous distributed computing environment, including remote file servers, computer servers, and memory storage devices. Each of these conventional distributed computing components can be accessible by the processor via a communication network.

The present invention may comprise a computer program or hardware or a combination thereof which embodies the functions described herein and illustrated in the appended flow charts. However, it should be apparent that there could be many different ways of implementing the invention in computer programming or hardware design, and the invention should not be construed as limited to any one set of computer program instructions. Further, a skilled programmer would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the remaining Figures illustrating other process flows.

According to one exemplary aspect of the invention, software located on either the customer premise equipment or set top box can monitor the current channel being transmitted to the customer's set top box and predict the next channel the customer may decide to tune. The customer premise equipment or set top box can cache the next channel stream's content in local memory by storing a MPEG I-frame at the cache head and the subsequent MPEG frame information following it. Therefore, when the user changes the channel to a cached stream, the customer premise equipment or set top box can immediately transmit the contents of the cache for that stream, thereby reducing the channel changing delay time.

For another exemplary aspect of the invention, the invention may be simplified by pre-caching only a single I-frame. When the user changes the channel, the single I-frame can then be transmitted to the set top box, and an IGMP join request can be transmitted upstream to locate the full program stream. This alternative exemplary embodiment affords the subscriber a quick preview of the channel without requiring significant memory, and it can also simplify the transfer of picture content from the buffer in the customer premise equipment to the set top box.

For another exemplary aspect of the invention, the invention can reduce channel change time by using an adaptive buffer length in the set top box. The buffer can implemented in a hardware and/or software configuration and serves to delay all packets arriving at the set top box by some length of time chosen by the set top box manufacturer. The buffer can monitor the current buffer fill capacity and increase or decrease the buffer length size in response to that capacity.

Referring now to the drawings, in which like numerals represent like elements, aspects of the exemplary embodiments will be described in connection with the drawing set.

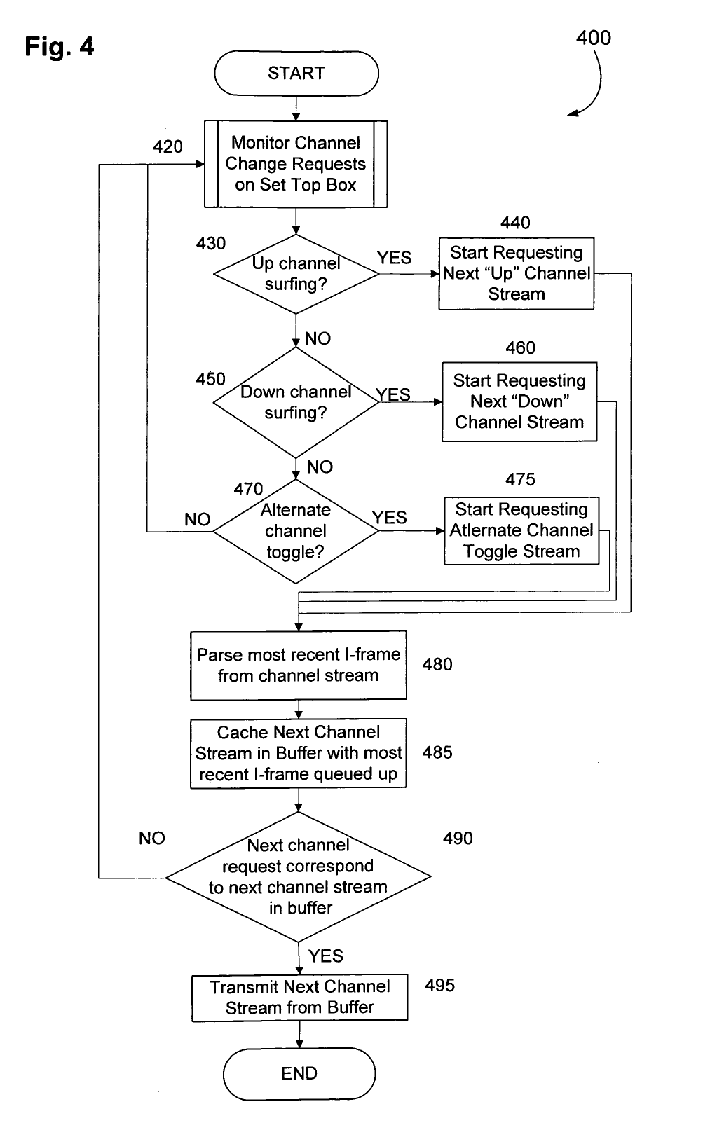

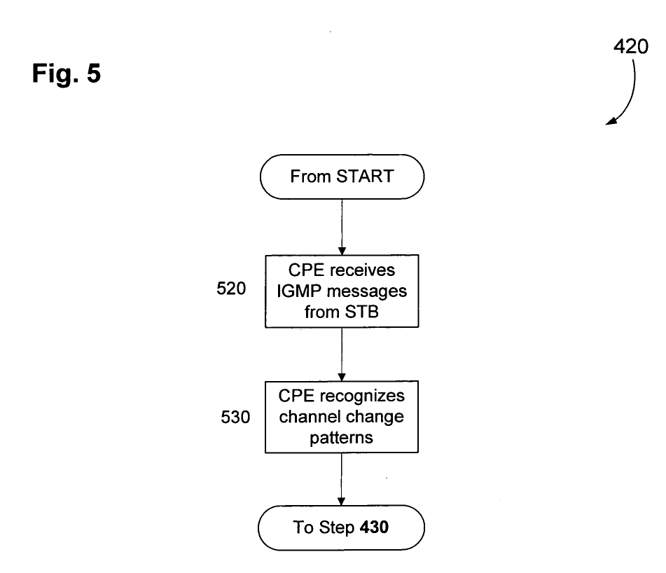

FIG. 4 is a logic flow diagram 400 illustrating an exemplary method for reducing channel change time in accordance with an exemplary embodiment of the invention. In the first Routine 420, the CPE 260 monitors the channel change requests on the STB 270 and predicts which channel the subscriber may tune to next. Further details of Routine 420 will be discussed below in FIG. 5.

Certain steps in the process described below must naturally precede others for the invention to function as described. However, the invention is not limited to the order of the steps described if such order or sequence does not alter the functionality of the invention. That is, it is recognized that some steps may be performed before or after or in parallel with other steps without departing from the scope and spirit of the invention.

In Decision Step 430, the CPE 260 determines if the subscriber is “surfing up,” or most likely to change to the television channel immediately higher than the tuned channel based on the pattern matching recommendation in Routine 420. If the subscriber is “surfing up,” the CPE 260 will begin requesting the next up channel stream in Step 440 by generating its own IGMP messages to join the multicast group corresponding to the next up channel stream. However, if the user is not “surfing up,” the CPE 260 will then check if the subscriber is “surfing down” in Decision Step 450 based on the pattern matching recommendation in Routine 420.

If the subscriber is “surfing down,” the next likely channel would be the television channel immediately preceding the tuned channel. If the subscriber is “surfing down,” the CPE 260 will begin requesting the next down channel stream in Step 460 by generating its own IGMP messages to join the multicast group corresponding to the next down channel stream. However, if the user is not “surfing down,” the CPE 260 will then check if the subscriber is alternating channels in Decision Step 470.

Finally, if the subscriber is alternating channels as determined in Decision Step 470, the CPE 260 will begin requesting the alternate channel stream in Step 475 by generating its own IGMP messages to join the multicast group corresponding to the alternate channel stream. However, if the user is not alternating channels in Step 470, then the channel change requests do no match a particular channel change pattern. Therefore, the CPE 260 will continue to monitor the channel changing on the STB 270 and return to Routine 420.

If the CPE 260 begins to request any of the three next channel streams in Steps 440, 460, or 475, the CPE 260 will parse out the most recent I-frame from the next channel stream in Step 480. In Step 485, the CPE 260 will store the next channel stream in a buffer with the most recent I-frame positioned at the beginning of the buffer. Therefore, as each new I-frame for the next channel stream is received by the CPE 260, the CPE 260 erases the current buffer contents and begins to store the subsequent stream traffic with the new I-frame positioned at the beginning of the buffer.

In Decision Step 490, the CPE 260 will monitor the channel change request on the STB 270 and determine whether the current channel change request corresponds to the next channel stream that is stored in the buffer. If the current channel change request does not correspond to the next channel stream that is stored in the buffer, the CPE 260 will continue to monitor the channel change requests on the STB 270 and return to Routine 420. However, in Step 495, if the current channel change request does correspond to the next channel stream that is stored in the buffer, the CPE 260 will transmit the next channel stream from the buffer to the STB 270.

FIG. 5 is a logic flow diagram illustrating an exemplary method for monitoring channel change requests 420 in accordance with an exemplary embodiment of the invention. Typically, the STB 270 is a member of a single multicast group, which corresponds to the television channel it is currently displaying. A conventional CPE 260 passes the STB's 270 IGMP join messages 285 upstream to the network to look for new channel multicast groups. In Step 520, the CPE 260 monitors the channel change requests on the STB 270 by receiving the IGMP messages 285, 295 transmitted by the STB 270. Software located on the CPE 260 analyzes the channel change requests of the subscriber and recognizes particular channel change patterns in Step 530. The channel change pattern information is then passed to Step 430 to determine whether it matches a particular next channel pattern.

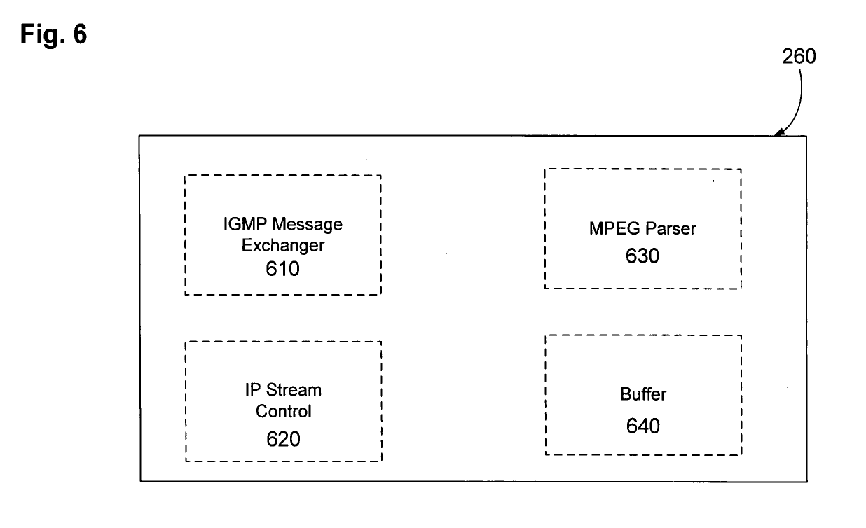

FIG. 6 is a block diagram illustrating basic elements of a CPE 260 in accordance with an exemplary embodiment of the invention. To implement an exemplary method for reducing channel change time in accordance with an exemplary embodiment of the invention, the CPE 260 usually comprises four basic elements that may be embodied in software or hardware or a combination thereof. One of the basic elements is the IGMP message exchanger 610. For the IGMP message exchanger 610, the CPE 260 must participate in the exchanging of IGMP messages between the STB 270 and the network 200. The CPE 260 monitors to the IGMP messages transmitted by the STB 270 to learn which channel the user is currently watching. Furthermore, the CPE 260 generates its own IGMP messages to join and leave other multicast groups. CPE 260 joins a group when it begins caching that group's content, and it leaves the group when caching is no longer necessary.

Another basic element of the CPE 260 is the IP Stream Control 620 block, which implements IP stream control. The IP Stream Control 620 block generally has three major functions. First, the IP Stream Control 620 block diverts any cached streams to the appropriate cache. Second, IP Stream Control 620 block retrieves information from a cache and forwards it to the STB 270 when the user tunes to a cached channel. Finally, the IP Stream Control 620 block stream control function ceases stream diversion for the active stream once that stream's cache is exhausted.

Another basic element of the CPE 260 is an MPEG parser 630. The MPEG parser 630 block examines the contents of each stream to locate the I-frames within the stream. When an I-frame arrives, it begins replenishing the cache starting with the new I-frame. After the new I-frame is completely received, the previous I-frame is discarded.

Another basic element of the CPE 260 includes the caches or buffers. For standard quality IP video using MPEG-2 encoding, each cached stream requires about 1 MByte of memory.

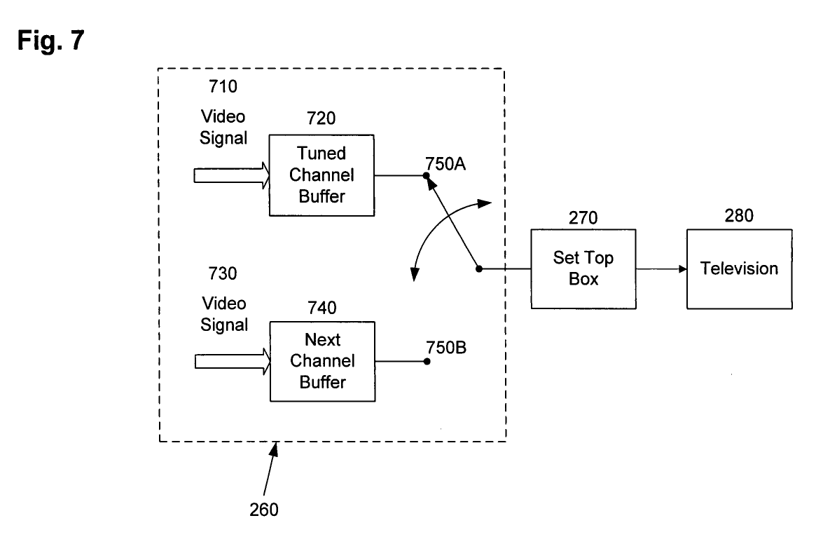

FIG. 7 is a block diagram illustrating basic elements of a CPE 260 in accordance with an exemplary embodiment of the invention. The CPE 260 provides a connection to the network 200 and is coupled to a router or switch 230C. In turn, the CPE 260 is coupled to a STB 270 typically using an Ethernet type of link. In an exemplary embodiment, the tuned channel buffer 620 on the CPE 260 will receive the video signal 710 from the network 200, that corresponds to the current channel on the STB 270. As long as the STB 270 is tuned to the current channel, the CPE 260 will transmit the current channel stream to the STB 270 to relay to the subscriber's television 280. The connection from the STB 270 to the television 280 may be standard coaxial cable, or it may be an alternative video connection such as S-Video or FireWire.

While the current channel stream is transmitted through the tuned channel buffer 720 to the STB 270, the next channel buffer 740 will receive the video signal 730 corresponding to the next channel stream as determined in Steps 440, 460, or 475. As discussed in reference to Step 480 and Step 485, the CPE 260 will parse the data signal 430 to receive the most recent I-frame and cache the next channel stream in the next channel buffer 740 with the most recent I-frame queued at the front of the next channel buffer 740. The next channel buffer 740 will continue to receive the video signal 730 corresponding to the next channel as determined in Steps 440, 460, or 475.

However, when the subscriber changes the channel in Step 495 on the STB 270, the CPE 260 will switch from the tuned channel buffer 720 at switch position 750A to the next channel buffer 740 at switch position 750B. The next channel buffer 740 will begin to transmit its channel stream with the I-frame at the front of the buffer 740 to the STB 270. The next channel buffer 740 will now be identified as the current channel buffer as it transmits the video signal 730 that corresponds to the current channel stream. Furthermore, the tuned channel buffer 720 will now be identified as the next channel buffer as it receives the video signal 610 that corresponds to the next channel stream as determined in Steps 440, 460, or 475.

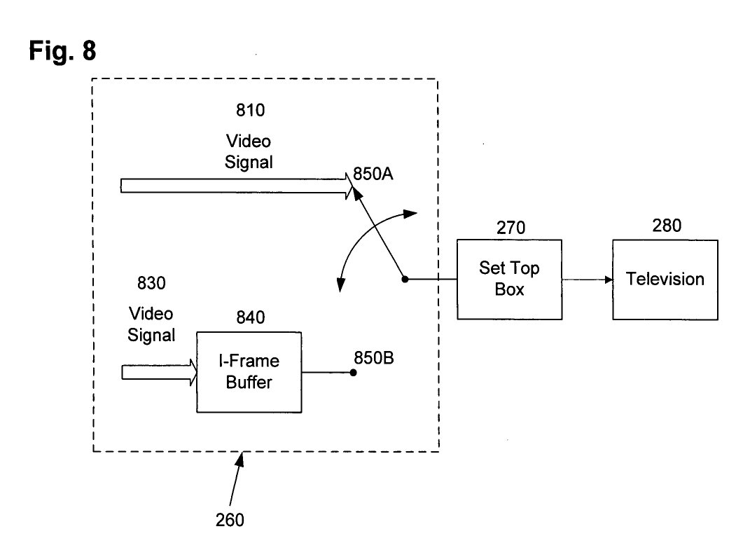

FIG. 8 is a block diagram illustrating further details of a CPE 260 in accordance with an alternative exemplary embodiment of the invention. Because the main objectives for a subscriber when he is surfing channels is to view what programs are available, the CPE 260 may be simplified somewhat by pre-caching only one I-frame. In this exemplary embodiment, the tuned channel buffer 820 on the CPE 260 will receive the video signal 810 from the network 200, that corresponds to the current channel of the STB 270. As long as the STB 270 is tuned to the current channel, the CPE 260 will transmit the current channel stream to the STB 270 to relay to the subscriber's television 280.

While the current channel stream is transmitted through switch position 850A to the STB 270, the I-frame buffer 840 will receive the video signal 830 corresponding to the next channel stream as determined in Steps 440, 460, or 475. As discussed in reference to Step 480 and Step 485, the CPE 260 will parse the video signal 430 to separate the most recent I-frame and cache only a single I-frame in the I-frame buffer 840. The I-frame buffer 840 will continue to receive the video signal 830 corresponding to the next channel as determined in Steps 440, 460, or 475. As the most recent I-frame corresponding to the next channel arrives in the video signal 830, the previous I-frame will be discarded from the I-frame buffer 840 and replaced with the new I-frame.

However, when the subscriber changes the channel in Step 495 on the STB 270, the CPE 260 will momentarily switch from the Video Signal 810 at switch position 850A to the I-frame buffer 840 at switch position 850B. The I-frame buffer 840 will immediately transmit the most recent I-frame to the STB 270. Then, the CPE 260 will switch back to switch position 850A from the I-frame buffer 840 at switch position 850B. As soon as the subscriber changes the channel, an IGMP join message 285 is transmitted to the network 200 to locate the full program stream that corresponds to the new requested channel. When located, the video signal 810 that corresponds to the current channel will immediately start being transmitted to the STB 270. As soon as a new I-frame is received, the moving video will be displayed.

The alternative exemplary embodiment illustrated in FIG. 8 provides a way for the STB 270 decoder to capture and display the I-frame as a still picture, until it begins receiving a full MPEG video stream for the selected channel. This affords the subscriber a quick preview of the channel without requiring as much memory, and it also simplifies the transfer of picture content from the buffer to the STB 270.

One of ordinary skill in the art, recognizes that the aspects and functions of the CPE 260 described above and represented in FIGS. 4-8 may be incorporated in the STB 270. That is, the software or hardware elements (or both) described above as being housed in CPE 260 could be implemented in a modified STB 270.

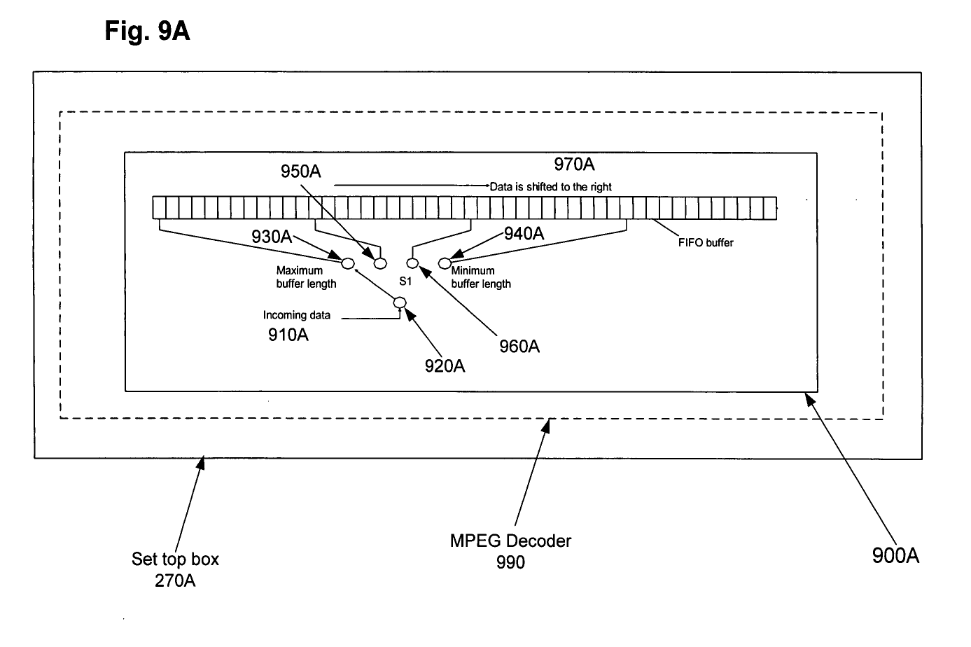

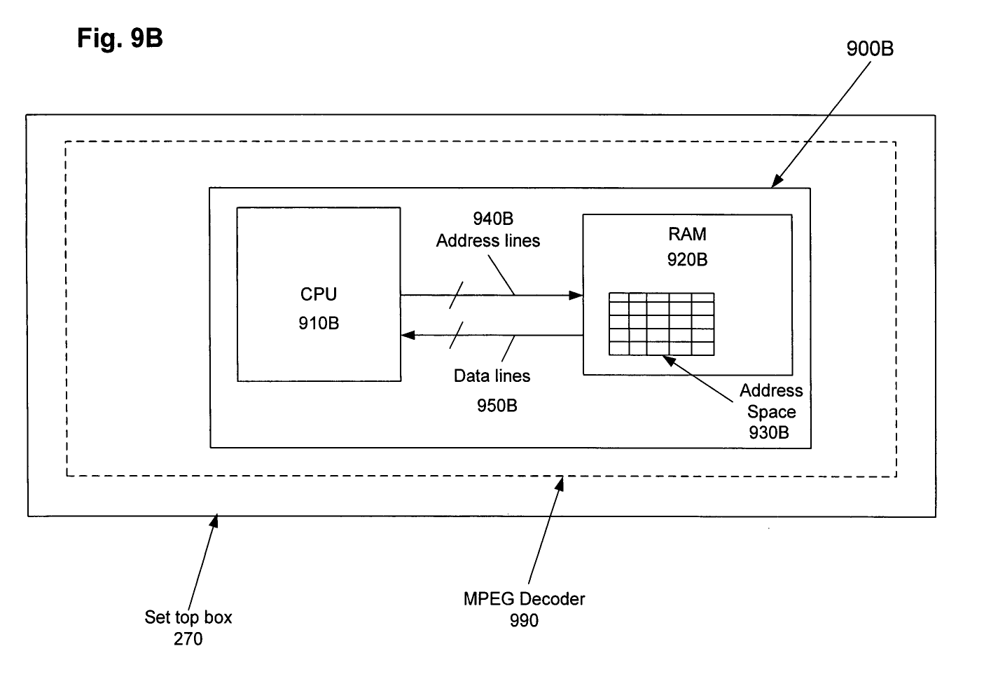

Referring now to FIG. 9A, this figure is a block diagram illustrating an adaptive variable length buffer 900A in accordance with an exemplary embodiment of the invention. The adaptive variable length buffer 900A is typically part of the STB MPEG decoder 990 and is responsible for receiving the incoming IP packet streams from a network 200 and decoding those packet streams in order for them to be displayed correctly on the subscriber's television 280. The buffer 900A in the exemplary embodiment in the STB MPEG decoder 990 can comprise a First-In-First-Out (FIFO) Shift Register. The buffer 900A serves to delay all packets arriving at the STB 270 by some length of time chosen by the STB 270 manufacturer. This buffer 900A is needed in order to prevent momentary picture “freezes,” which can occur if for some reason a packet is delayed in getting to the STB 270. To one of ordinary skill in the art, the buffer 900A is usually sized such that the longest packet delay time expected is less than the buffer length.

When a subscriber changes channels, incoming data 910A begins filling up the buffer 900A with frames that correspond to the channel currently requested by the subscriber. The incoming data 910A is shifted to the right 970A in the buffer 900A as it begins to fill up. Typically, when the buffer 900A reaches approximately a fifty percent (50%) capacity, the data is transmitted to the STB MPEG decoder 990.

Depending on the amount of jitter in the incoming data 910A, the variable length buffer 900A can adjust its length to consistently keep the buffer 900A around halfway full. If the variable length buffer 900A averages around a fifty percent (50%) capacity, data will continuously be shifted to the right direction 970A and transmitted to the STB MPEG decoder 990. However, if the variable length buffer 900A is nearly full most of the time, it will most likely be necessary to move the switch 920A of the buffer to the maximum buffer length 930A to prevent the buffer from overfilling and potentially losing portions of the incoming data 910A. In the alternative, if the variable length buffer 900A is nearly empty much of the time, it is too long and it will most likely be preferable to move the switch 920A of the buffer to the minimum buffer length 940A to prevent the buffer from consistently dropping below the fifty-percent (50%) capacity threshold and causing excessive delays in channel change time. Finally, switch positions 950A and 960A can be provided for intermediate buffer lengths if the extremes of the maximum buffer length 930A or minimum buffer length 940A are not required to maintain the buffer capacity around the 50% threshold.

To express the situation more rigorously, if the system is introducing a lot of jitter, a longer buffer may be needed to remove the jitter before preventing the data to the decoder. The amount of jitter being introduced by the system may be monitored by looking at how full buffer 900A gets. If buffer 900A regularly fills to a high percentage, then it is too small, and can be lengthened by moving switch 920A in a counterclockwise direction as seen in FIG. 9A. On the other hand, if the buffer 920A stays, for example, less than 50% full, then it can be shorter without causing any problems. This can be accomplished by moving switch 920A in a clockwise direction as seen in FIG. 9A.

The switch 920A cannot be moved while receiving a channel, so it must be moved upon a channel change. Thus, the buffer fill is monitored over a significant length of time, and adjustments to the buffer length are made when the subscriber changes the channel.

FIG. 9B is a block diagram illustrating an adaptive variable length buffer 900B in accordance with an alternative exemplary embodiment of the invention. The adaptive variable length buffer 900B is typically part of the STB MPEG decoder 990 and is responsible for receiving the incoming IP packet streams from the network 200 and decoding those packet streams in order for them to be displayed correctly on the subscriber's television 280.

FIG. 9B represents the typical hardware and/or software used to form a variable length buffer 900B in the present art. The buffer 900B in the exemplary embodiment in the STB MPEG decoder 990 can comprise FIFO memory. This variable length buffer 900B typically includes a CPU 910B and RAM 920B with address space 930B. When a subscriber changes channels, incoming data is stored in the address space 930B of the RAM 920B. The CPU 910B controls the location and size of this address space 930B by using pointers across the address lines 940B. When requested, data is returned from the buffer portion of RAM 920B to the CPU 910B, which can then pass the data to the STB MPEG decoder 990. Similar to the discussion of FIG. 9A above, the CPU 910B can adjust the address space locations for the storage of the incoming data in order to maintain a consistent transmission of data to the STB MPEG Decoder 990; thereby, minimizing tuning delays consistent with the jitter of the system.

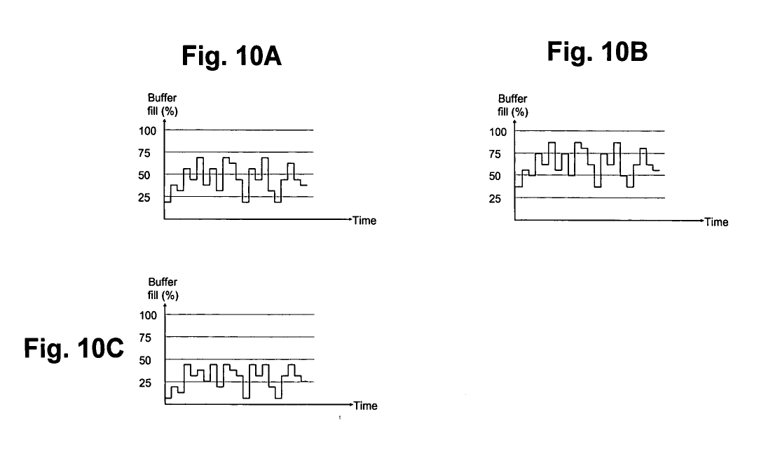

FIG. 10A is a graph illustrating the result of monitoring the buffer fill for some length of time where the buffer length is sized correctly The graph illustrates that the buffer fill percentage averages around the fifty-percent (50%) threshold. Therefore, the switch 920A position for the buffer 900A in FIG. 8A would not need to be changed from its current position at this time.

FIG. 10B is a graph illustrating the result of monitoring the buffer fill for some length of time where the buffer length is sized too small. The graph illustrates that the buffer fill percentage averages above the fifty-percent (50%) threshold. Therefore, the switch 920A position for the buffer 900A in FIG. 8A would most likely need to be changed from its current position to the maximum buffer length switch position 930A. The increase in the buffer length size could bring the buffer fill down to the fifty-percent (50%) threshold. Failing to increase the buffer length size could potentially cause the buffer to overflow, or lose data, which could cause the loss of incoming data.

FIG. 10C is a graph illustrating the result of monitoring the buffer fill for some length of time where the buffer length is sized too large. The graph illustrates that the buffer fill percentage averages below the fifty-percent (50%) threshold. Therefore, the switch 920A position for the buffer 900A in FIG. 8A would most likely need to be changed from its current position to the minimum buffer length switch position 940A. The decrease in the buffer length size could bring the buffer fill up to the fifty-percent (50%) threshold. Failing to decrease the buffer length size could cause excess channel tuning delay while a too-large buffer if filled.

Many other modifications, features and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. A method for minimizing the channel change time for IP digital video comprising the steps of:
receiving a first channel stream of IP digital video from a network;
monitoring channel change requests to change the IP digital video;
matching the channel change requests to at least one channel change pattern;
in response to matching a channel change request to a channel change pattern, requesting a second channel stream of IP digital video from the network corresponding to the channel change pattern;
receiving the second channel stream of IP digital video in a storage device; and
transmitting the second channel stream of IP digital video from the storage device to a display device.

2. The method of claim 1, wherein the step of monitoring the channel change requests comprises the steps of:
receiving a plurality of IGMP messages related to the channel change requests transmitted by the set top box; and
analyzing the plurality of IGMP messages to determine whether the IGMP messages match one of a plurality of channel change patterns.

3. The method of claim 1, wherein the plurality of channel change patterns comprises at least one of:
a surfing up pattern;
a surfing down pattern;
an alternating channel pattern; and
no pattern.

4. The method of claim 1, wherein the step of requesting the second channel stream of IP digital video comprises the steps of:
sending an IGMP join message corresponding to the second channel stream of IP digital video to the network; and
receiving the second channel stream of IP digital video from the network.

5. The method of claim 1, wherein the step of receiving the second channel stream of IP digital video in the storage device comprises the steps of:
parsing the second channel stream of IP digital video to identify most recent I-frame;
storing a most recent I-frame at the beginning of the storage device; and
storing a plurality of subsequent frames in the storage device,
wherein the plurality of subsequent frames do not include an I-frame.

6. The method of claim 1, wherein the step of receiving the second channel of IP digital video stream in the storage device further comprises:
parsing the second channel stream of IP digital video to identify most recent I-frame; and
storing a most recent I-frame in the storage device.

7. The method of claim 1, wherein the step of transmitting the second channel stream of IP digital video from the storage device comprises the steps of:
monitoring a new channel on the set top box when a subscriber changes channels;
determining whether the new channel corresponds to the second channel stream of IP digital video in the storage device; and
in response to the new channel corresponding to the second channel stream of IP digital video in storage device, transmitting the second channel stream of IP digital video to the set top box.

8. A method for minimizing the channel change time for IP digital video comprising the steps of:
receiving a channel stream of IP digital video from a network in a storage device;
monitoring the fill capacity of the storage device; and
in response to the fill capacity reaching a predetermined threshold for a duration of time, altering the size of the storage device.

9. The method of claim 8, wherein the step of monitoring the fill capacity of the storage device comprises the step of analyzing the fill capacity of the storage device to determine whether the fill capacity matches one of a plurality of storage device sizes.

10. The method of claim 9, wherein the plurality of storage device sizes comprises at least one of the predetermined threshold;
a size that is smaller than the predetermined threshold; and
a size that is greater than the predetermined threshold.

11. The method of claim 8, wherein the step of altering the size of the storage device comprises the step of:
determining whether the size of the storage device is at the predetermined threshold; and
in response to the determination that the size of the storage device cannot handle the predetermined threshold, increasing the size of the storage device so that it is larger than the predetermined threshold.

12. A system for minimizing the channel change time for IP digital video comprising:
a first storage device for receiving a first channel stream of IP digital video from a network;
a customer premise equipment operable for monitoring channel change requests to change the IP digital video and matching the channel change requests to at least one channel change pattern; and in response to matching the channel change request to a channel change pattern, requesting a second channel stream of IP digital video from the network corresponding to the channel change pattern; and
a second storage device for receiving the second channel stream of IP digital video and transmitting the second channel stream of IP digital video from the storage device to a display device.

13. The system of claim 12, wherein the customer premise equipment is further operable for monitoring the channel change requests by:
receiving a plurality of IGMP messages related to the channel change requests transmitted by a set top box; and
analyzing the plurality of IGMP messages to determine whether the IGMP messages match one of a plurality of channel change patterns.

14. The system of claim 12, wherein the plurality of channel change patterns comprises at least one of:
a surfing up pattern;
a surfing down pattern;
an alternating channel pattern; and
no pattern.

15. The system of claim 12, wherein the customer premise equipment is further operable for requesting the second channel stream of IP digital video by:
sending an IGMP join message corresponding to the second channel stream of IP digital video to the network; and
receiving the second channel stream of IP digital video from the network at a second storage device.

16. The system of claim 12, wherein the second storage device is operable for receiving the second channel stream of IP digital video by:
parsing the second channel stream of IP digital video to identify most recent I-frame;
storing a most recent I-frame at the beginning of the second storage device; and
storing a plurality of subsequent frames in the second storage device,
wherein the plurality of subsequent frames do not include an I-frame.

17. The system of claim 12, wherein the step of receiving the second channel of IP digital video stream in the second storage device further comprises:
parsing the second channel stream of IP digital video to identify most recent I-frame; and
storing a most recent I-frame in the second storage device.

18. The system of claim 12, wherein the second storage device is further operable for transmitting the second channel stream of IP digital video by:
monitoring a new channel on the set top box when a subscriber changes channels;
determining whether the new channel corresponds to the second channel stream of IP digital video in the storage device; and
in response to the new channel corresponding to the second channel stream of IP digital video in storage device, transmitting the second channel stream of IP digital video to the set top box.

19. The system of claim 12, wherein the customer premise equipment can comprise a set top box.
